(19) United States
(12) Patent Application Publication
(10) Pub. No.: US 2025/0238121 A1
(43) Pub. Date: Jul. 24, 2025

(54) DISPLAY CONTROL METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Zhaoyuan PENG, Beijing (CN); Yichen LI, Beijing (CN); Yingdi SUN, Beijing (CN); Tianhao HE, Beijing (CN); Jian DU, Beijing (CN)

(21) Appl. No.: 18/705,467

(22) PCT Filed: Nov. 4, 2022
(86) PCT No.: PCT/CN2022/129943

§ 371 Date: Apr. 26, 2024

(30) Foreign Application Priority Data
Nov. 8, 2021 (CN) 202111313898.4

(51) Int. Cl. G06F 3/0483; G06F 3/0482; G06F 3/04845; G06F 3/0485

(52) U.S. Cl. CPC G06F 3/0483; G06F 3/0482; G06F 3/04845; G06F 3/0485

(57) ABSTRACT

A display control method, device, electronic device and storage medium are provided. The display control method includes: arranging opened pages of a target application in a form of continuous task flow, and displaying a first page which is recently opened among the opened pages in a display area; and displaying, in response to a first preset operation, a second page adjacent to the first page among pages arranged in the form of continuous task flow in the display area.

### CROSS-REFERENCE TO RELATED APPLICATION

This application is based on China patent application with application number of 202111313898.4 and application date of Nov. 8, 2021, entitled “DISPLAY CONTROL METHOD AND APPARATUS, AND ELECTRONIC DEVICE AND STORAGE MEDIUM”, and claims the priority of the China patent application, the disclosure of which is incorporated herein by reference.

### TECHNICAL FIELD

The invention relates to the technical field of computers, in particular to a display control method, device, electronic device and storage medium.

### BACKGROUND

Terminals, such as mobile phones, usually use the page flow structure of layer-by-layer progressive and tree navigation, which leads to the need for users to keep going back and forth in multiple task flows when processing multiple tasks in parallel, lead to long operation path and low efficiency. When users operate the terminals, the operations are performed step by step, for example, a second-level page may be triggered by a first-level page, and a third-level page may be triggered by the second-level page.

### SUMMARY

The invention provides a display control method, device, electronic device and storage medium.

The present disclosure adopts the following technical scheme.

In some embodiments, the present disclosure provides a display control method, including:
arranging opened pages of a target application in a form of continuous task flow, and displaying a first page which is recently opened among the opened pages in a display area; and
displaying, in response to a first preset operation, a second page adjacent to the first page among pages arranged in the form of continuous task flow in the display area.

In some embodiments, the present disclosure provides a display control device, including:
a display unit, which is configured to arrange opened pages of a target application in a form of continuous task flow, and display a first page which is recently opened among the opened pages in a display area; and
a control unit, which is configured to display, in response to a first preset operation, a second page adjacent to the first page among pages arranged in the form of continuous task flow in the display area.

In some embodiments, the present disclosure provides an electronic device including at least one memory and at least one processor;

wherein, the at least one memory is configured to store program codes, and the at least one processor is configured to cause the program codes stored in the at least one memory to execute the method mentioned-above.

In some embodiments, the present disclosure provides a computer-readable storage medium with program codes stored thereon, wherein the program codes, when executed by a processor, causes the processor to perform the method mentioned-above.

The present disclosure provides a display control method, which includes: arranging opened pages of a target application in a form of a continuous task flow, and displaying a first page which is recently opened among the opened pages in a display area; and, displaying, in response to a first preset operation, a second page adjacent to the first page among pages arranged in the form of continuous task flow in the display area. The embodiments of the present disclosure simplify the operations that users need to perform when jumping between pages, and is convenient for users to switch and display pages.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic and elements and components are not necessarily drawn to scale.

FIG. 1 is a flowchart of a display control method according to embodiments of the present disclosure.

FIG. 2 is a display schematic diagram of a target application according to embodiments of the present disclosure.

FIG. 3 is a display schematic diagram of a target application according to embodiments of the present disclosure.

FIG. 4 is a display schematic diagram of a target application according to embodiments of the present disclosure.

FIG. 5 is a schematic display diagram of a full-screen display state and a non-full-screen display state according to embodiments of the present disclosure.

FIG. 6 is a schematic structural diagram of an electronic device according to embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the scope of the present disclosure.

It should be understood that various steps described in the method embodiments of the present disclosure can be performed and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”. The term “another embodiment” means “at least one other embodiment”. The term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modification of “one” mentioned in this disclosure is schematic rather than limiting, and those skilled in the art should understand that it should be understood as “one or more” unless the context clearly indicates otherwise.

Names of messages or information exchanged among multiple devices in the embodiments of the present disclosure are only used for illustrative purposes, and are not used to limit the scope of these messages or information.

The scheme provided by the embodiments of the application will be described in detail with the attached drawings.

In the related art, pages in terminals such as mobile phones often adopt a tree structure, in which the related secondary page is opened in the primary page, and the related tertiary page is opened in the secondary page, and so on. When jumping between two secondary pages under different primary pages, the user needs to return from one secondary page to one primary page, and then sink from the primary page to another secondary page, which causes inconvenience to users.

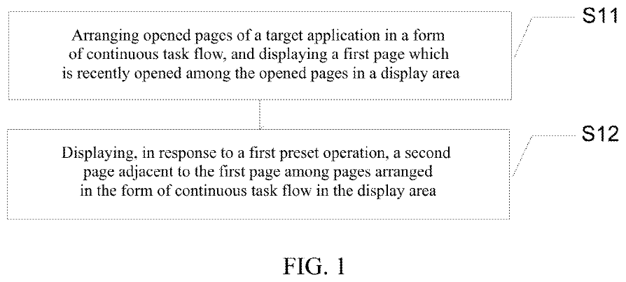

As shown in FIG. 1, FIG. 1 is a flowchart of a display control method according to embodiments of the present disclosure, including the following steps S11 and S12.

S11: Arranging opened pages of a target application in a form of continuous task flow, and displaying a first page which is recently opened among the opened pages in a display area.

S12: Displaying, in response to a first preset operation, a second page adjacent to the first page among the pages arranged in the form of continuous task flow in the display area.

In some embodiments, the target application can be any application, such as an instant messaging application, the display area is the display area of the target application, and the pages opened in the target application are unified into a continuous task flow, which refers to a collection of continuous pages. In the embodiments, every page opened is added into the continuous task flow, and there is no longer the concept of the home page and hierarchical structure, and the page logic is changed from a tree structure to a linear structure. According to the user's operation, a new page is opened and stays in the newly opened first page. In the related art, a tree-like hierarchical structure is adopted, which has the disadvantage that the page switching cost is high and the operations of returning back and forward need to be continuously performed. In the present application, a linear structure is adopted, and there is no tree-like hierarchical structure between pages, and all the opened pages are continuously arranged, and then the user can switch the displayed page to a second page adjacent to the displayed page through a first preset operation. This has the advantage of reducing the cost of page switching. When it is necessary to jump between different pages, as long as the page to jump to has been opened in the continuous task flow, the page to jump to can be switched to the display area for display, and different pages are displayed as independent pages, so there is no need to perform operations of returning to the previous page and sinking to the next level page, thus simplifying the operations required by the user when jumping between pages. In some embodiments of the disclosure, for an opened page, as long as a closing operation is not performed on it, the page will not be closed, thus, after this page is switched, this switched page can be used immediately without waiting for loading this page, in which the response speed can be improved.

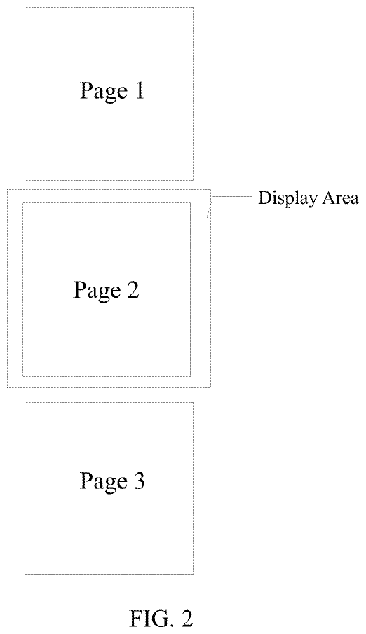

For example, in the related art, there is a tree structure root node with a first leaf node and a second leaf node under a root node. After the first leaf node is opened, if the user wants to open the second leaf node, the steps of returning back to the root node from the first leaf node and then going to the second leaf node are needed, which requires repeated operations in every switching operation. In the present disclosure, once two pages have been opened, they are added to the continuous task flow and can be displayed in the form of continuous arrangement in the vertical direction. Switching between the pages to be displayed can be performed by sliding up and down. For details, refer to FIG. 2. The continuous task flow includes Page 1, Page 2 and Page 3, which are arranged in sequence in the vertical direction, and one page is displayed at a time. Page 2 is located in the display area, and Page 1 and Page 3 are located outside the display area. Switching the pages to be displayed is performed by sliding up and down vertically without going back to the previous level and going down, thus, the efficiency is improved.

In some embodiments of the application, the opened pages are respectively carried in page cards, and the page cards are arranged in the form of continuous task flow. In some embodiments, a page card is one display style of a page. The difference between a page card and a general window is that when new content is opened in a page card, the new content is always opened in the form of a new card instead of changing the content displayed in the page card. For example, if the content corresponding to a logo is opened, the content of the logo is always opened in the form of a new page card instead of changing the content displayed in the page card itself to the content corresponding to the logo, that is, every time a page is opened, a new page card is created. This has the advantage that the two page cards retain the contents displayed before and after the page cards are opened, so that it is convenient for users to compare the contents displayed before and after the page card is opened. In the embodiments, the display contents of an original page card is not changed when opening a new page is needed, but open a new page card for display the new page, so that the contents of the accessed page cards can be retained and the cost of backtracking by users can be reduced.

A page card is a unit for the target application to carry pages. For example, a page card can be an independent window. The pages in the target application are carried by page cards, and the page cards displayed in the display area can be switched. In some embodiments of the present disclosure, the page of the target application is displayed in the form of a page card, and when a new page is opened, the page card bearing the new page will be opened instead of changing the page in an original page card, and the page card displayed in the display area can be switched, so that when it is necessary to jump between different pages, as long as the page card corresponding to the page to be jumped to has been opened, the page card corresponding to the page to be jumped to can be switched to the display area for display. In the embodiments of the disclosure, different pages do not have tree-like hierarchical relationship, and different pages are displayed by independent page cards, so there is no need to return to the previous page and go down to the next page, thus simplifying the operations that users need to perform when jumping to the page. In some embodiments of the disclosure, for the opened page cards, as long as a closing operation is not performed on it, the page card will not be closed, so after switching the page card, the switched page card can be displayed immediately without waiting for the page card to be loaded, which improves the response speed.

In some embodiments of the present disclosure, the first preset operation is an upward sliding operation or a downward sliding operation. In some embodiments, the pages in the continuous task flow are all arranged in the vertical direction, so the pages to be displayed are switched by sliding up or down in the vertical direction.

In some embodiments of the present disclosure, the display control method further includes opening and displaying a third page of the target application in the display area in response to a triggering operation of a first identifier in the target application, wherein the third page is inserted in a position adjacent to the second page in the task flow.

In some embodiments of the present disclosure, the second page is displayed before the third page is opened, which indicates that the two pages may be related. For example, when a user wants to compare with another page when viewing a document, the third page is opened, so the third page will be displayed adjacent to the second page, which can facilitate the user to compare the second page with the third page.

In some embodiments of the present disclosure, the third page pushes the second page out of the display area upward or downward, and the opened pages are arranged in the form of vertical continuous task flow.

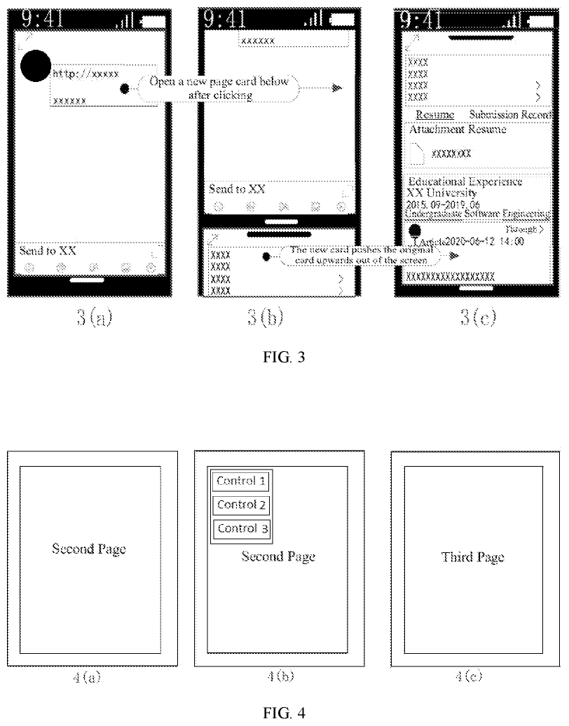

In some embodiments, refer to FIG. 3, which schematically shows the schematic diagram that the third page pushes the second page out of the display area. After opening the third page in the target application, the second page will be moved out of the display area, that is, after opening a new page card, the new page card will be displayed and the old page card will be moved out, so that the user will always stay in the newly opened page card.

In some embodiments of the present disclosure, opening and displaying the third page of the target application in the display area in response to the triggering operation of the first identifier in the target application includes: opening and displaying the third page of the target application in the display area in response to a trigger operation of an identifier in the second page.

In some embodiments, reference can be made to FIG. 3(a), where a logo is displayed in the second page (for example, the link http://xxxxxxxxxxxx shown in FIG. 3(a)), and after the logo in the second page shown in FIG. 3(a) is triggered, a third page will be created for displaying, as shown in FIG. 3(a), where the displayed page is the second page with a link as the logo. As shown in FIG. 3(b), the third page below the second page will be opened, and the second page and the third page will be arranged side by side along the vertical direction of the terminal display screen, and the third page will push the second page card out of the display area upwards. Finally, as shown in FIG. 3(c), only one page is displayed in the display area, that is, the third page is displayed.

In some embodiments of the present disclosure, opening and displaying the third page of the target application in the display area in response to the triggering operation of the first identifier in the target application includes: displaying a control option bar, wherein the control option bar includes at least one control; and opening, in response to a triggering operation of a first control in the control option bar, a third page associated with the first control and displaying the third page in the display area.

In some embodiments, the control option bar can be displayed in the target application all the time, or it can be displayed in response to a second preset operation. In this embodiment, the control option bar can be a function navigation for carrying a function entry, and the function entry is a control. For example, refer to FIG. 4, FIG. 4(a) shows a second page, after a second preset operation is detected, as shown in FIG. 4(b), option controls are displayed, including control 1, control 2 and control 3. The second preset operation can be a sliding operation, for example, the second preset operation is a right sliding operation or a left sliding operation. By triggering any option in the option control, the corresponding third page can be opened and displayed, as shown in FIG. 4(c).

In some embodiments of the present disclosure, a display size of the control option bar is determined based on the number of controls in the control option bar. In some embodiments, the display size of the control option bar is not fixed, and it will be adjusted adaptively according to the number of controls in it. For example, the controls in the control option bar can be arranged vertically, and the height of the control option bar in the vertical direction can be adjusted adaptively according to the number of controls.

In some embodiments of the present disclosure, after the third page associated with the first control is opened, the control option bar is hidden. In some embodiments, the control option bar is automatically hidden to avoid obscuring the page.

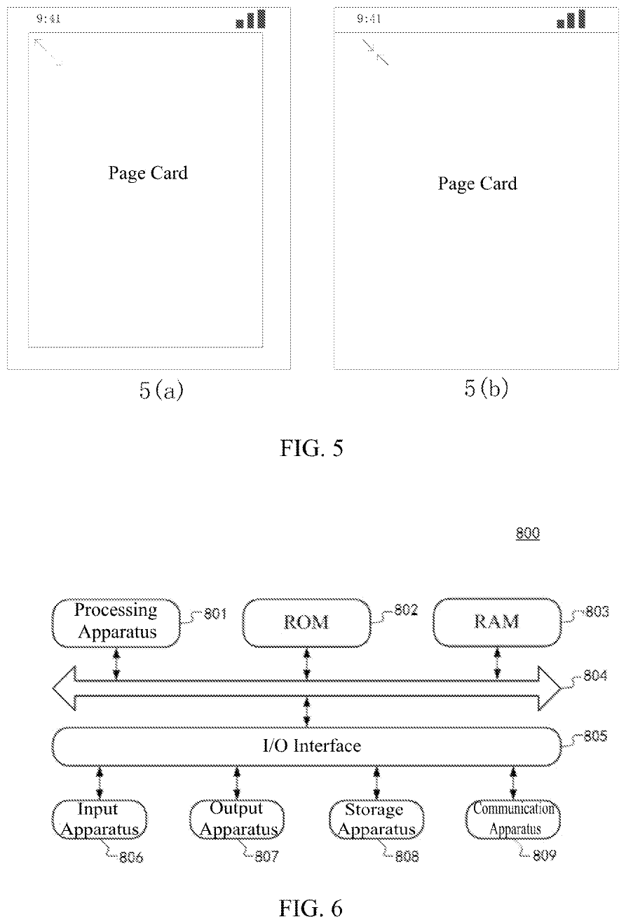

In some embodiments of the present disclosure, a page in the continuous task flow includes a full-screen display state and a non-full-screen display state, and the page is provided with a display control for controlling the page to switch between the full-screen display state and the non-full-screen display state. In some embodiments, when the currently displayed page is in a non-full screen state by default, the size of the page is a preset size, and when the page is in a full screen state, the page will be displayed in full screen. Refer to FIG. 5, FIG. 5(a) shows a non-full screen display state with a display control (two opposite arrows) in the upper left corner of the page. At this time, the display control is triggered to expand the page, and the page will be displayed in full screen state as shown in FIG. 5(b). At this time, if the display control in the upper left corner is triggered, the page will be switched back to the non-full screen state. In some embodiments, the page displayed in the display area cannot be switched when the page displayed in the display area is in the full screen state, and the page displayed in the display area can only be switched when the page displayed in the display area is in the non-full screen state.

In some embodiments of the present disclosure, the display control method further includes: scrolling and displaying, in response to a third preset operation, pages in the continuous task flow, and displaying a fourth page located in the display area when the scrolling stop. In some embodiments, the pages are arranged in parallel along the longitudinal direction of the screen, and the third preset operation may be to slide up or down along the longitudinal direction to switch the pages displayed in the display area.

In some embodiments of the present disclosure, scrolling and displaying, in response to the third preset operation, pages in the continuous task flow, and displaying, in response to a fourth preset operation on a fourth page among the scrolled and displayed pages, the fourth page. In some embodiments, pages are arranged side by side in the longitudinal direction. The third preset operation can be an upward sliding operation with a sliding speed greater than a speed threshold or a downward sliding operation with a sliding speed greater than a speed threshold. The fourth preset operation can be a click operation. When sliding up or down quickly, the pages opened in the target application will be scrolled in sequence in the longitudinal direction, and the pages located in the display area will be displayed as the fourth page when scrolling stops. It can be automatically stopped, or it can be manually stopped by the user. For example, when the page is scrolled, if the user clicks one of the pages, it will stop scrolling and display the clicked page as the fourth page.

In some embodiments of the present disclosure, the display control method further includes: in response to a fifth preset operation on a page displayed in the display area, closing the page on which the fifth preset operation is performed. In some embodiments, the fifth preset operation may be to slide from left to right in the horizontal direction after a long press on the page, so that the page card can be closed to prevent the page card from occupying resources.

In some embodiments, after closing the page on which the fifth preset operation is performed, a page adjacent to the closed page in the continuous task flow is displayed, because the closed card is usually related to its adjacent page, so the page adjacent to the closed page can be displayed. In other embodiments, after closing the page on which the fifth preset operation is performed, the most recently accessed page among the remaining pages in the continuous task flow is displayed. The most recently accessed page card in the remaining pages may be determined according to the access time of the page.

In order to better illustrate the method proposed in the embodiments of the present disclosure, a specific embodiment is listed below. In this embodiment, all pages of the target application are carried by page cards, which are arranged side by side along the longitudinal direction of the screen, and only one page card is displayed in the display area. The page card displayed in the display area can be switched by sliding the page card up or down. Each page card is equivalent to a unit in the task flow (task flow is a collection of page cards opened to perform a task). Users can scroll the page cards by sliding up and down, thus shuttling through the task flow to reduce the number of operation steps required for page jumping. Users can click a control in the page card to open a new page card vertically below the page card displayed in the current display area. Page cards can be arranged vertically. When a page card is newly opened, the previously displayed page card will be pushed out of the display area, and the user can trigger to open a new page card in a page card. The user can slide from the left edge of the screen to the right to trigger the option control bar, in which there are controls as function entrances, and the controls in the option control bar are arranged vertically. The height of the option control bar is adjusted adaptively according to the number of options. By clicking a control (such as a document control), a corresponding page card can be opened. After the option control bar is triggered, if it is not used for more than a preset time, it will be automatically hidden. The upper left corner of the page card can have a display control, so as to control the page card to switch between the full-screen display state and the non-full-screen display state. The user can delete a page card by a right sliding operation. In this embodiment, pages in the target application no longer have a hierarchical structure, and the page logic is changed from a tree structure to a linear structure. According to the user's operation, a new page card is triggered to be opened, and the user can stay in the newly opened page card of the current task flow.

Some embodiments of the present disclosure can reduce the operation cost of the user switching between different pages, and the option control bar can quickly switch to other task scenarios. In some embodiments of the present disclosure, the target application will keep a preset number of recently opened page cards in chronological order, which is convenient for users to quickly trace back and switch, and reduces the operation cost.

In some embodiments of the present disclosure, a display control device is provided, including:
A display unit, which is configured to arrange opened pages of a target application in a form of continuous task flow, and display a first page which is recently opened among the opened pages in a display area;
A control unit, which is configured to display, in response to a first preset operation, a second page adjacent to the first page among pages arranged in the form of continuous task flow in the display area.

In some embodiments, the opened pages are respectively carried in page cards, and the page cards are arranged in the form of continuous task flow.

In some embodiments, the first preset operation is an upward sliding operation or a downward sliding operation.

In some embodiments, the control unit is further configured to open and display a third page of the target application in the display area in response to a triggering operation of a first identifier in the target application, wherein the third page is inserted in a position adjacent to the second page in the task flow.

In some embodiments, the third page pushes the second page out of the display area upward or downward, and the opened pages are arranged in the form of vertical continuous task flow.

In some embodiments, opening and displaying the third page of the target application in the display area in response to the triggering operation of the first identifier in the target application includes: opening and displaying the third page of the target application in the display area in response to a triggering operation of an identifier in the second page; or, displaying a control option bar, wherein the control option bar includes at least one control, and opening, in response to a triggering operation of a first control in the control option bar, a third page associated with the first control and displaying the third page in the display area.

In some embodiments, the displaying the control option bar includes: displaying the control option bar in response to a second preset operation; and/or determining a display size of the control option bar based on the number of controls in the control option bar.

In some embodiments, at least one of the following is satisfied: the second preset operation is a right sliding operation or a left sliding operation; the control option bar is hided after opening the third page associated with the first control.

In some embodiments, a page in the continuous task flow includes a full-screen display state and a non-full-screen display state, and the page is provided with a display control for controlling the page to switch between the full-screen display state and the non-full-screen display state.

In some embodiments, the control unit is further configured to: scroll and display, in response to a third preset operation, pages in the continuous task flow, and display a fourth page located in the display area when the scrolling stops; or,

scroll and display, in response to the third preset operation, pages in the continuous task flow, and display, in response to a fourth preset operation on a fourth page among the scrolled and displayed pages, the fourth page.

In some embodiments, the third preset operation is an upward sliding operation with a sliding speed greater than the speed threshold, or a downward sliding operation with a sliding speed greater than the speed threshold; and/or the fourth preset operation is a click operation.

In some embodiments, the control unit is further configured to: in response to a fifth preset operation on a page displayed in the display area, close the page on which the fifth preset operation is performed.

In some embodiments, the control unit is further configured to: after closing the page on which the fifth preset operation is performed, display a page adjacent to the closed page in the continuous task flow; or, after closing the page on which the fifth preset operation is performed, display a most recently accessed page among remaining pages in the continuous task flow.

For the embodiments of the device, because it basically corresponds to the method embodiments, it is only necessary to refer to the partial description of the method embodiments for relevant points. The device embodiments described above are only schematic, wherein the modules described as separate modules may or may not be separate. Some or all of the modules can be selected according to actual needs to achieve the purpose of the embodiments. Ordinary technicians in this field can understand and implement it without creative labor.

Above, the method and device of the present disclosure have been described based on embodiments and application examples. In addition, the present disclosure also provides a terminal and a storage medium, which are described below.

Reference is now made to FIG. 6, which shows a structural schematic diagram of an electronic device (such as a terminal device or a server) 800 suitable for implementing embodiments of the present disclosure. The terminal devices in the embodiments of the present disclosure may include, but are not limited to, mobile terminals such as mobile phones, notebook computers, digital broadcast receivers, PDA (Personal Digital Assistant), PAD (Tablet Computer), PMP (Portable Multimedia Player), vehicle-mounted terminals (such as vehicle-mounted navigation terminals), and fixed terminals such as digital TV and desktop computers. The electronic device shown in the figure is only an example, and should not bring any limitation to the function and application scope of the disclosed embodiments.

As shown in FIG. 6, an electronic device 800 may include a processing apparatus (such as a central processing unit, a graphics processor, etc.) 801, which may perform various appropriate actions and processes according to a program stored in a read-only memory (ROM) 802 or a program loaded from a storage apparatus 808 into a random-access memory (RAM) 803. In the RAM 803, various programs and data required for the operation of the electronic device 800 are also stored. A processing apparatus 801, a ROM 802 and a RAM 803 are connected to each other through a bus 804. An input/output (I/O) interface 805 is also connected to the bus 804.

Generally, the following apparatuses can be connected to the I/O interface 805: an input apparatus 806 including, for example, a touch screen, a touch pad, a keyboard, a mouse, a camera, a microphone, an accelerometer, a gyroscope, etc.; An output apparatus 807 including, for example, a liquid crystal display (LCD), a speaker, a vibrator, etc.; a storage apparatus 808 including, for example, a magnetic tape, a hard disk, etc; and, a communication apparatus 809. The communication apparatus 809 may allow the electronic device 800 to communicate wirelessly or wired with other devices to exchange data. Although the electronic device 800 with various apparatus is shown in the figure, it should be understood that it is not required to implement or have all the apparatuses as shown. More or fewer apparatuses may alternatively be implemented or provided.

In particular, according to embodiments of the present disclosure, the process described above with reference to the flowchart can be implemented as a computer software program. For example, an embodiment of the present disclosure includes a computer program product, which includes a computer program carried on a computer-readable medium, and the computer program contains program code for executing the method shown in the flowchart. In such an embodiment, the computer program can be downloaded and installed from the network through the communication apparatus 809, or installed from the storage apparatus 808, or installed from the ROM 802. When the computer program is executed by the processing apparatus 801, the above functions defined in the method of the embodiments of the present disclosure are performed.

It should be noted that the computer-readable medium mentioned above in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or element, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this disclosure, a computer-readable storage medium can be any tangible medium containing or storing a program, which can be used by or in combination with an instruction execution system, apparatus or device. In this disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer-readable medium can be transmitted by any suitable medium, including but not limited to: wires, optical cables, RF (radio frequency) and the like, or any suitable combination of the above.

In some embodiments, the client and the server can communicate by using any currently known or future developed network protocol such as HTTP (HyperText Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc end-to-end networks), as well as any currently known or future developed networks.

The computer-readable medium may be included in the electronic device; Or it can exist alone without being assembled into the electronic device.

The computer-readable medium carries one or more programs, which, when executed by the electronic device, cause the electronic device to perform the method of the present disclosure.

Computer program codes for performing the operations of the present disclosure may be written in one or more programming languages or combinations thereof, including object-oriented programming languages such as Java, Smalltalk, C++, and conventional procedural programming languages such as “C” or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. Among them, the name of the unit does not constitute the limitation of the unit itself in some cases.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of this disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

According to one or more embodiments of the present disclosure, there is provided a display control method, including:
arranging opened pages of a target application in a form of continuous task flow, and displaying a first page which is recently opened among the opened pages in a display area; and
displaying, in response to a first preset operation, a second page adjacent to the first page among pages arranged in the form of continuous task flow in the display area.

According to one or more embodiments of the present disclosure, there is provided a display control method, wherein the opened pages are respectively carried in page cards, and the page cards are arranged in the form of continuous task flow.

According to one or more embodiments of the present disclosure, a display control method is provided, wherein the first preset operation is an upward sliding operation or a downward sliding operation.

According to one or more embodiments of the present disclosure, there is provided a display control method, which further includes: opening and displaying a third page of the target application in the display area in response to a triggering operation of a first identifier in the target application, wherein the third page is inserted in a position adjacent to the second page in the task flow.

According to one or more embodiments of the present disclosure, there is provided a display control method, wherein the third page pushes the second page out of the display area upward or downward, and the opened pages are arranged in a form of vertical continuous task flow.

According to one or more embodiments of the present disclosure, there is provided a display control method, wherein the opening and displaying the third page of the target application in the display area in response to the triggering operation of the first identifier in the target application includes:
opening and displaying the third page of the target application in the display area in response to a triggering operation of an identifier in the second page; or,
displaying a control option bar, wherein the control option bar includes at least one control, and opening, in response to a triggering operation of a first control in the control option bar, a third page associated with the first control and displaying the third page in the display area.

According to one or more embodiments of the present disclosure, there is provided a display control method, wherein the displaying the control option bar includes: displaying the control option bar in response to a second preset operation; and/or,
determining a display size of the control option bar based on a number of controls in the control option bar.

According to one or more embodiments of the present disclosure, there is provided a display control method, wherein at least one of the following is satisfied: the second preset operation is a right sliding operation or a left sliding operation;
the control option bar is hided after opening the third page associated with the first control.

According to one or more embodiments of the present disclosure, a display control method is provided, wherein a page in the continuous task flow includes a full-screen display state and a non-full-screen display state, and the page is provided with a display control for controlling the page to switch between the full-screen display state and the non-full-screen display state.

According to one or more embodiments of the present disclosure, there is provided a display control method, wherein the method further includes:
scrolling and displaying, in response to a third preset operation, pages in the continuous task flow, and displaying a fourth page located in the display area when the scrolling stops; or,
scrolling and displaying, in response to the third preset operation, pages in the continuous task flow, and displaying, in response to a fourth preset operation on a fourth page among the scrolled and displayed pages, the fourth page.

According to one or more embodiments of the present disclosure, there is provided a display control method, wherein the third preset operation is an upward sliding operation with a sliding speed greater than a speed threshold or a downward sliding operation with a sliding speed greater than a speed threshold; and/or,
the fourth preset operation is a click operation.

According to one or more embodiments of the present disclosure, there is provided a display control method, wherein the method further includes:
in response to a fifth preset operation on a page displayed in the display area, closing the page on which the fifth preset operation is performed.

According to one or more embodiments of the present disclosure, there is provided a display control method, wherein the method further includes:
after closing the page on which the fifth preset operation is performed, displaying a page adjacent to the closed page in the continuous task flow; or,
after closing the page on which the fifth preset operation is performed, displaying a most recently accessed page among remaining pages in the continuous task flow.

According to one or more embodiments of the present disclosure, there is provided a display control device, which includes:
a display unit, which is configured to arrange opened pages of a target application in a form of continuous task flow, and display a first page which is recently opened among the opened pages in a display area; and
a control unit, which is configured to display, in response to a first preset operation, a second page adjacent to the first page among pages arranged in the form of continuous task flow in the display area.

According to one or more embodiments of the present disclosure, there is provided an electronic device including:
at least one memory and at least one processor;
wherein, the at least one memory is configured to store program codes, and the at least one processor is configured to cause the program codes stored in the at least one memory to execute the method described in any one of the above.

According to one or more embodiments of the present disclosure, there is provided a computer-readable storage medium with program codes stored thereon, wherein the program codes, when executed by a processor, causes the processor to perform the method described in any one of the above.

The above description is only the preferred embodiments of the present disclosure and the explanation of the applied technical principles. It should be understood by those skilled in the art that the scope involved in this disclosure is not limited to the technical scheme formed by the specific combination of the above technical features, but also covers other technical schemes formed by any combination of the above technical features or their equivalent features without departing from the above disclosure concept. For example, the above features can be replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A display control method, comprising:
arranging opened pages of a target application in a form of continuous task flow, and displaying a first page which is recently opened among the opened pages in a display area; and
displaying, in response to a first preset operation, a second page adjacent to the first page among pages arranged in the form of continuous task flow in the display area.

2. The method according to claim 1, wherein,
the opened pages are respectively carried in page cards, and the page cards are arranged in the form of continuous task flow.

3. The method according to claim 1, wherein,
the first preset operation is an upward sliding operation or a downward sliding operation.

4. The method according to claim 1, wherein the method further comprises:
opening and displaying a third page of the target application in the display area in response to a triggering operation of a first identifier in the target application, wherein the third page is inserted in a position adjacent to the second page in the task flow.

5. The method according to claim 4, wherein,
the third page pushes the second page out of the display area upward or downward, and the opened pages are arranged in a form of vertical continuous task flow.

6. The method according to claim 4, wherein opening and displaying the third page of the target application in the display area in response to the triggering operation of the first identifier in the target application comprises:
opening and displaying the third page of the target application in the display area in response to a triggering operation of an identifier in the second page;
or,
displaying a control option bar, wherein the control option bar comprises at least one control, and opening, in response to a triggering operation of a first control in the control option bar, a third page associated with the first control and displaying the third page in the display area.

7. The method according to claim 6, wherein the displaying the control option bar comprises:
displaying the control option bar in response to a second preset operation; and/or
determining a display size of the control option bar based on a number of controls in the control option bar.

8. The method according to claim 7, wherein at least one of the following is satisfied:
the second preset operation is a right sliding operation or a left sliding operation;
the control option bar is hided after opening the third page associated with the first control.

9. The method according to claim 1, wherein,
a page in the continuous task flow comprises a full-screen display state and a non-full-screen display state, and the page is provided with a display control for controlling the page to switch between the full-screen display state and the non-full-screen display state.

10. The method according to claim 1, further comprising:
scrolling and displaying, in response to a third preset operation, pages in the continuous task flow, and displaying a fourth page located in the display area when the scrolling stops; or
scrolling and displaying, in response to the third preset operation, pages in the continuous task flow, and displaying, in response to a fourth preset operation on a fourth page among the scrolled and displayed pages, the fourth page.

11. The method according to claim 10, wherein,
the third preset operation is an upward sliding operation with a sliding speed greater than a speed threshold or a downward sliding operation with a sliding speed greater than a speed threshold; and/or
the fourth preset operation is a click operation.

12. The method according to claim 1, further comprising:
in response to a fifth preset operation on a page displayed in the display area, closing the page on which the fifth preset operation is performed.

13. The method according to claim 12, further comprising:
after closing the page on which the fifth preset operation is performed, displaying a page adjacent to the closed page in the continuous task flow; or
after closing the page on which the fifth preset operation is performed, displaying a most recently accessed page among remaining pages in the continuous task flow.

14. (canceled)

15. An electronic device, comprising:
at least one memory and at least one processor,
wherein, the at least one memory is configured to store program codes, and the at least one processor is configured to cause the program codes stored in the at least one memory to execute a display control method, wherein the method comprises:
arranging opened pages of a target application in a form of continuous task flow, and displaying a first page which is recently opened among the opened pages in a display area; and
displaying, in response to a first preset operation, a second page adjacent to the first page among pages arranged in the form of continuous task flow in the display area.

16. A computer-readable storage medium with program codes stored thereon, wherein the program codes, when executed by a processor, causes the processor to perform the method according to claim 1.

17. The electronic device according to claim 15, wherein the opened pages are respectively carried in page cards, and the page cards are arranged in the form of continuous task flow, and wherein the first preset operation is an upward sliding operation or a downward sliding operation.

18. The electronic device according to claim 15, wherein the display control method further comprises:
opening and displaying a third page of the target application in the display area in response to a triggering operation of a first identifier in the target application, wherein the third page is inserted in a position adjacent to the second page in the task flow, and
wherein the third page pushes the second page out of the display area upward or downward, and the opened pages are arranged in a form of vertical continuous task flow.

19. The electronic device according to claim 18, wherein the opening and displaying the third page of the target application in the display area in response to the triggering operation of the first identifier in the target application comprises:
opening and displaying the third page of the target application in the display area in response to a triggering operation of an identifier in the second page;
or,
displaying a control option bar, wherein the control option bar comprises at least one control, and opening, in response to a triggering operation of a first control in the control option bar, a third page associated with the first control and displaying the third page in the display area.

20. The electronic device according to claim 19, wherein the displaying the control option bar comprises:
displaying the control option bar in response to a second preset operation; and/or
determining a display size of the control option bar based on a number of controls in the control option bar.

21. The electronic device according to claim 15, wherein a page in the continuous task flow comprises a full-screen display state and a non-full-screen display state, and the page is provided with a display control for controlling the page to switch between the full-screen display state and the non-full-screen display state.
